(19) United States
(12) Patent Application Publication
(10) Pub. No.: US 2006/0003064 A1
(43) Pub. Date: Jan. 5, 2006

(54) Synergistic co-location of process plants

(76) Inventor: Peter John James, Newstead (AU)

Correspondence Address: David P Dureska;Buckingham Doolittle & Burroughs, 4518 Fulton Drive N W, P O Box 35548, Canton, OH, 44735-5548, US

(21) Appl. No.: 10/533,180

(22) PCT Filed: Apr. 29, 2003
(86) PCT No.: PCT/AU03/00501

§ 371 Date: Apr. 29, 2005

(30) Foreign Application Priority Data
Nov. 4, 2002 (AU) 2002952423

(51) Int. Cl. A23P 1/00

(52) U.S. Cl. 426/481

(57) ABSTRACT

Legume fodder crops, grown as soil-enhancing fallow crops for sugar cane, are processed in feed mills co-located with existing cane sugar mills to produce animal feed products, such as hay, with a positive economic value. The process uses some of the sugar mills' excess fibre by-product (bagasse) as the energy source for the dehydration of the fodder.

### BACKGROUND OF THE INVENTION

(1) Field of the Invention

THIS INVENTION relates to the synergistic co-location of process plants.

The invention is particularly suitable for, but not limited to, use of a cane sugar mill as the location of another, additional agroindustrial process plant (hereinafter referred to as “the feed mill”) to process agricultural crop(s) other than sugar cane.

In particular, the feed mill may be used to process legume fodder crop(s), suitable for haymaking, such as lucerne (known as alfalfa in the USA) which are grown as a fallow crop in the sugar cane farming cycle.

Throughout the specification the term “legume fodder crops” shall include:
(a) Lucerne (alfalfa) (perennial) Medicago sativa
(b) Clovers (perennial) numerous varieties
(c) Soybeans (annual) Glycine max
(d) Lespedeza (annual) Lespedeza cuneata
(e) Cowpeas (annual) Vigna ungulculata
(f) Trefoil (perennial) Trifollum sp
(g) Mung beans (annual) Vigna sp
(h) Lablab beans (annual) Dilochus lablab or Lablab purpureus
(i) Velvet beans (annual) Mucuna sp
(j) Stylo (perennial; South American equivalent of lucerne) Stylosanthes sp.
(k) Townsville stylo (annual) Stylosanthes humilis
   and the like.

Such crops have the following advantages:
1. They are high yielding (tonnes per hectare).
2. They are rich in protein.
3. Their protein's essential amino acids composition is better balanced for feeding animals than grain protein.
4. They are the highest in calcium of farm-grown feeds.
5. They have high vitamin A value, even higher when artificially dehydrated.
6. They are rich in other vitamins.
7. They increase the yield of grasses when grown together, or successively.
8. They are very important in maintaining soil fertility. Nitrogen fixing bacteria in legume root nodules increase yields of succeeding crops by increasing soil nitrogen supply and making soil nitrogen more chemically active and available.
9. Deep rooted legumes such as lucerne and sweet clover penetrate and open up soil layers below the plough line. The roots provide organic matter which keeps the soil particles aggregated and porous, this improving soil structure.
10. For optimum ongoing results it is best to grow legumes in regular crop rotations with other crops.

(2) Prior Art

Cane sugar mills require very large capital investment, which can only be recovered during the relatively short cane crushing season(s), which may total 5 to 7 months per year.

Similarly, the associated transport infrastructure, which, in the case of cane railway systems, is also a very significant capital investment, is only used for half of the year.

The use of cane sugar mills to produce products other than cane sugar from sugar cane is known.

The journal article “System for the Production of Electricity, Leaf Protein and Single Cell Protein from Sugar Cane Top and Leaves” (K. Deepchand), reported at Solar Energy Vol. 35 No. 6, pp 477-482. 1985, describes the processing of sugar cane tops and leaves, to provide feedstock for protein separation and bio chemical production of single cell protein.

The journal article “The Use of Sugar Cane and By-Products for Livestock” (T. R. Peston) reported in Chemistry and World Food Supplies: the new frontiers, Chemrawn II: untitled papers presented at the International Conference on Chemistry and World Food Supplies, Manila, Philippines, Dec. 6-10, 1982, published by Pergamon Press, Oxford, 1983, pp 221-236 describes the fractionation of sugar cane stalks to produce juice and digestible fibre fractions for feeding ruminant and monogastric animals.

In both articles, the processing only relates to sugar cane or sugar cane by-products of the sugar cane harvesting/milling processes.

Jeremy Woods, Department of Life Sciences, Kings College, London, UK
http://www.kcl.ac.uk/ip/jwoods/sorghum/thesis/Ch2.pdf
http://www.kcl.ac.uk/ip/jwoods/sorghum/thesis/Ch3.pdf
http://www.kcl.ac.uk/ip/jwoods/sorghum/thesis/Ch4.pdf
http://www.kcl.ac.uk/ip/jwoods/sorghum/thesis/Ch5.pdf
(Date of publication is unconfirmed)
   discloses integrating sweet sorghum into a sugar cane mill. The thesis describes the processing of sweet sorghum, which is a grass type of crop somewhat similar to sugar cane, in the sugar cane mill itself to produce fermentable materials as feedstock for ethanol manufacture and combustible fibre as a fuel source.

The crushing and processing of sweet sorghum to produce a sweet sugary syrup (in much the same way that sugar cane was crushed and processed in the early nineteenth century) is well known and was practised in the USA until the early twentieth century, after which it was discontinued as a commercial exercise, presumably because it was uneconomic. (Refer http://www.herculesengines.com/sorghum/default.html.)

It must be noted that the end product of the process is not an animal feed product, and the growth of sweet sorghum as a fallow crop for sugar cane would be expected to reduce the yield of succeeding crops, as sorghum has a reputation for reducing the yield of succeeding grass type crops (e.g. grains, sugar cane) due to its relatively low nitrogen content.

The sorghum process disclosed by Woods does not include the following advantageous features of the present invention:

i. A processing plant separate from the sugar cane processing plant which can operate in parallel with, or independently of, the sugar cane processing plant;

ii. The processing of a legume fallow crop, the cultivation of which crop has positive benefits for the succeeding sugar cane crops;

iii. A product which is a storable animal feedstuff and more particularly, one which is high in protein, and for these reasons more valuable than the sorghum process products;

iv. The use of the sugar mill's excess energy resources in the form of waste heat in its boiler flue gases or in its fibrous by-product bagasse fuel, as the energy source to dehydrate the legume fodder crop to render it storable.

Legume fodder crops have been grown for many years as a source of stored animal feed, e.g. hay, but full nutritive benefits of such stored animal feed, e.g. hay, have not been realisable due to losses arising in conventional harvesting and processing methods.

The Agricultural Utilization Research Institute (AURI) (USA) notes the following with regard to Alfalfa Production:

“Alfalfa has been grown as a source of animal feed for many years. Methods for producing and harvesting the crop for hay have greatly improved over time, however, one of the major problems associated with alfalfa hay production requires the crop be dried in the field and subjected to weather related yield and quality losses.

Alfalfa provides many agronomic and environmental benefits to agriculture. Alfalfa;

1. is an alternative, high value crop;

2. increases soil structure;

3. increased soil organic matter; and

4. provides a perennial legume into the rotation to help break disease and insect cycles.

Despite the advantages, alfalfa acreage and production has decreased by 10% and 13%, respectively, from 1986 to 1997. The decreased production has occurred while the price of alfalfa has increased over 30%. Some of the reasons why production levels have decreased during this time including the following:

1. Limited means to control quality.
The crop is subject to yield and quality losses while drying in the field;
Mechanical losses during crop collection [i.e., after drying in the field];
Many alfalfa processing plants have been lost with plant inefficiency [i.e., energy inefficient because of high fuel costs for drying], the inability to supply high quality product and the lack of focus on the customer's needs; and
Blending facilities are not available to guarantee product formulation.

2. Harvesting is difficult to schedule; and

3. There is no well established system to market the product.”

### SUMMARY OF THE INVENTION

It is an object of the present invention to use a cane sugar mill as the location of another, additional feed mill to process legume fodder crop(s) to produce an animal feed product.

It is a preferred object to provide the feed mill to process the legume fodder crop(s), such as lucerne/alfalfa or the like, which are grown as soil-enhancing fallow crops on sugar cane farms to generate a positive income from such fallow crops.

It is a still further preferred object to use the existing sugar cane transport system/infrastructure, e.g., the cane railway system, to transport the legume fodder crop.

It is a still further preferred object to co-ordinate, schedule and integrate the harvesting and transport of the legume fodder crop with the sugar cane harvesting and transport to minimise delay between harvesting and processing in order to maximise the nutrient value of the processed crop.

It is a still further preferred object to use the waste heat and excess power produced by the sugar mill from the combustion of its by-product bagasse to process the legume fodder crop most economically.

It is a still further preferred object to arrange the sugar mill process so that sufficient excess by-product bagasse is made available for storage and use as fuel for processing the legume fodder crop during those months of the year when the sugar mill is not in use processing sugar cane, in order that the amount of legume fodder crop to be processed may be maximised.

It is a further preferred object to provide such a feed mill which can process both coarse and fine dry fibre and which can mix the fibre with extracted juice concentrate, molasses and the like.

It is a still further preferred object to provide a feed mill which can effect pressure compaction, cubing, extrusion, moulding, tableting, granulation, agglomeration, briquetteing, baling, bagging and other like processing of the resultant feed.

Other preferred objects will become apparent from the following description.

In one aspect the present invention resides in a method of processing a legume fodder crop (as hereinbefore defined), including the steps of:

(a) delivering with minimum delay, freshly harvested legume fodder crop to a feed mill located at adjacent to a cane sugar mill;

(b) processing the crop to seek optimised cell breakage and/or fiberisation (i.e., separation of fibre particles) in the resultant shredded material, depending on final product specifications as required; and

(c) drying the shredded material using heat supplied by the cane sugar mill or from by-products of the cane sugar mill to produce a dried animal feed material, suitable for long term storage.

Preferably, the method includes the further step:

(d) mixing the dried material with suitable liquid binder(s) to produce a feed meal material of suitable moisture content as required for use.

Preferably, in step (a), the freshly harvested crop is delivered to the feed mill in bulk using the transport system/infrastructure of the cane sugar mill.

Preferably, in step (b), the harvested crop is shredded using heavy duty shredder/hammermill machines.

Preferably, the juice is extracted, concentrated, and stored in liquid concentrate tank(s).

Preferably, in step (c), the shredded matter is dried using hot flue gas from the sugar mill boiler, or from a separate furnace fired with sugar cane bagasse either fresh from the cane sugar mill or from a stockpile.

The dried shredded material may be separated into coarse (e.g., stem) and fine (e.g. leaf) dry fibre fractions, which may be selectively recombined during later processing.

Preferably, in step (d), the liquid binder(s) include molasses, juice concentrate and other suitable liquids to achieve the desired moisture content.

During, or after, step (d) other ingredients and additives such as vitamins, minerals, digestion improvers, antibiotics, other pharmaceuticals and the like may be added to increase the value of the feed meal material.

After step (d), the feed meal material may undergo further processing such as pelletising, crumbling, granulation, agglomeration, pressure compaction, cubing, extrusion, moulding, tableting, briquetting, baling, bagging or the like to suit the market requirements.

In a second aspect, the present invention resides in a method of processing a legume fodder crop (as hereinbefore defined) including the steps of:

(a) delivering with minimum delay, freshly harvested legume fodder crop to a feed mill located at adjacent to a cane sugar mill;

(b) processing the crop to produce cut and/or shredded material; and

(c) drying the cut and/or shredded material using heat supplied by the cane sugar mill or from by-products of the cane sugar mill to produce a dried animal feed material, suitable for long term storage.

Preferably, the method includes the further step:

(d) baling the dried cut and/or shredded material (or hay).

Preferably in step (b), the crop is processed using rotary knives to cut and/or shred the fibrous material, if necessary to meet product requirements.

Preferably, after step (d), the baled material (or hay) is outloaded or containerised for transport.

Preferably, at step (d), molasses may be mixed with the dried material (or hay) to increase the nutritional value thereof.

In third and fourth aspects, the present invention resides in a method for producing an animal feed product including the steps:

growing a legume fodder crop (as hereinbefore defined) as a soil-enhancing fallow crop for sugar cane; and

processing of the crop by the method of the first and second aspects, respectively.

### BRIEF DESCRIPTION OF THE DRAWINGS

To enable the invention to be fully understood, preferred embodiments will now be described with reference to the accompanying drawings, in which:

FIG. 1 shows a systems diagram for the operation of the invention during the sugar cane crushing season;

FIG. 2 is a similar systems diagram for the sugar cane non-crushing season;

FIG. 3 is a feed mill system diagram for the feed mill shredder and optional juice extraction and concentration plant subsystems;

FIG. 4 is a feed mill system diagram for the drying plant and optional size separation and degritting plant subsystems;

FIG. 5 is a feed mill system diagram for continuous mixing and optional batch mixing plant subsystems;

FIG. 6 is a feed mill system diagram for the pellet mill subsystems;

FIG. 7 is a feed mill system diagram for the outloading and bagging plant subsystems;

FIG. 8 is a systems diagram (similar to FIGS. 1 and 2) for the operation of the invention with a separate hot gas generating furnace; and

FIG. 9 is a systems diagram (similar to FIG. 8) for the production of a baled hay product.

### DETAILED DESCRIPTION OF THE PREFERRED EMBODIMENTS

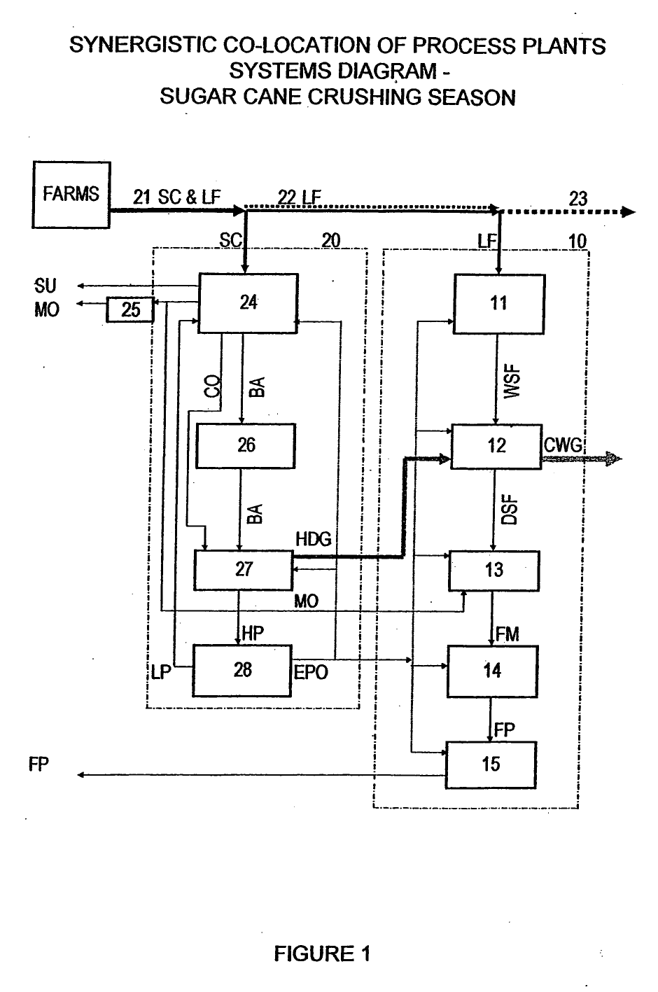

Referring to FIG. 1, freshly harvested legume fodder crop LF e.g. lucerne/alfalfa, is transported to the feed mill 10 (to be hereinafter described in more detail), co-located with a cane sugar mill 20, on full trucks 21 of a common existing sugar cane SC railway or road transport system 22, the empty trucks 23 being dispatched to be reloaded with the legume fodder crop.

The operation of the cane sugar mill 20 during the sugar cane crushing season is illustrated schematically in FIG. 1 and incorporates a sugar mill process unit 24. Molasses MO produced from the sugar cane is directed to a storage tank 25 and/or the feed mill 10; while bagasse BA is directed to a stockpile 26, from which it is drawn off to fire a boiler 27 which provides high pressure (H.P.) steam for the powerhouse 28 to generate electricity, which can be employed to operate the feed mill 10. Hot dry flue gas HDG from the boiler 27 is used to dry the shredded crop.

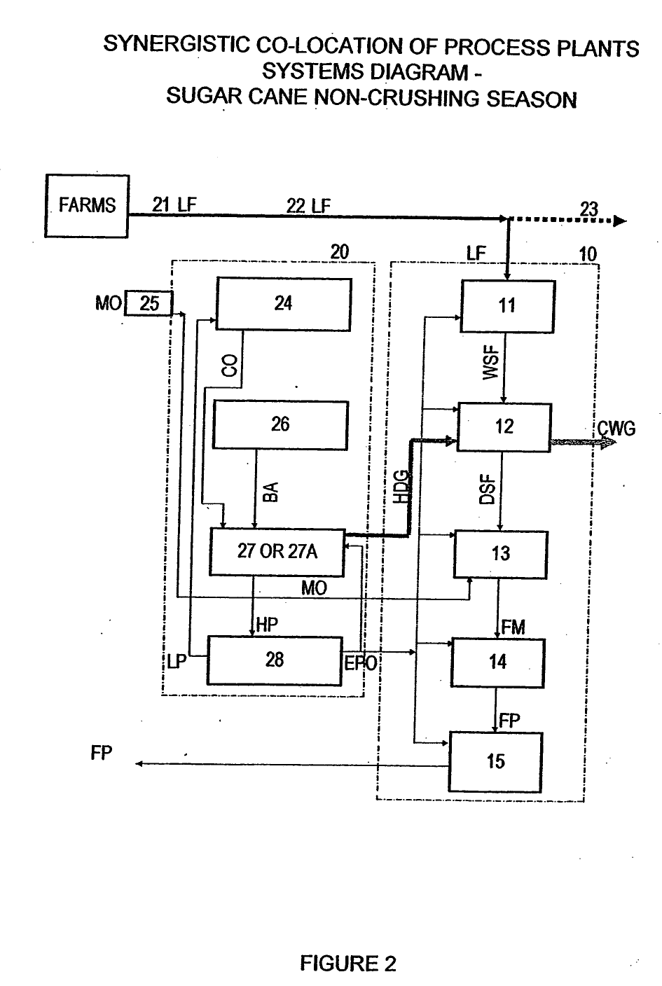

In the non-crushing season, schematically illustrated in FIG. 2, molasses MO can be drawn from the storage tank 25 to be mixed with the shredded fibre; and bagasse BA can be drawn from the bagasse stockpile 26 to fire the boiler 27 (under reduced steaming) or a furnace with no steam, the hot dry flue gas HDG from the boiler 27 and/or the furnace 27A being used to dry the shredded crop.

Where the boiler 27 supplies high pressure (H.P.) steam to the power house 28, the sugar mill evaporators in the process unit 24 can be used as condensers to condense the exhaust or low pressure (L.P.) steam from the power house 28 with the condensate CO being returned as feedwater to the boiler 27.

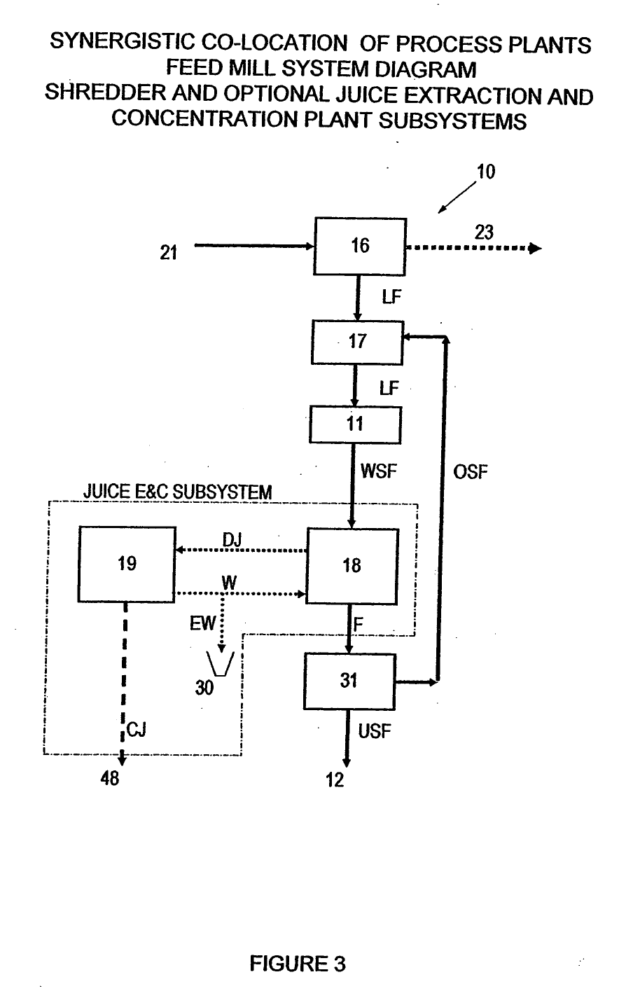

The general process steps followed in the feed mill 10 are schematically illustrated in FIGS. 1 and 2 (and will be described in more detail with reference to FIGS. 3 to 7).

The feed mill 10 receives the fresh harvested legume fodder crop, which is passed through shredders/hammermill machines in the shredder 11. After shredding, the juice may be extracted and concentrated, to be described with reference to FIG. 3.

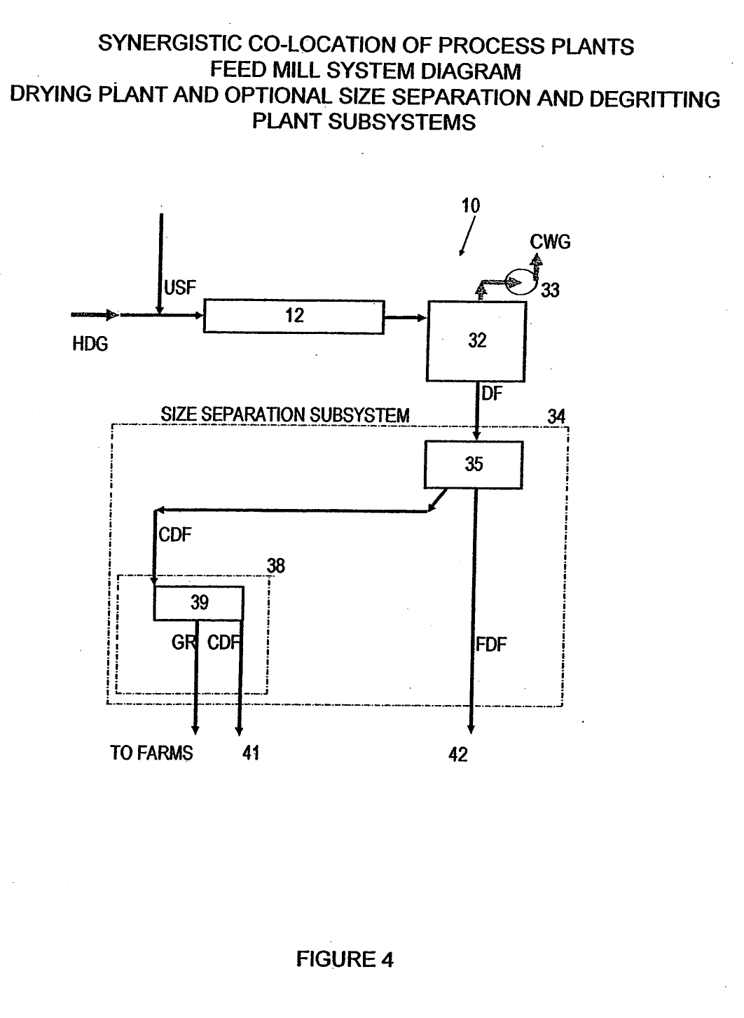

Wet shredded fodder WSF is fed to the drying plant 12, to be dried by the hot dry flue gas HDG (as shown in FIG. 1), and the resulting cool wet gas CWG may be vented to atmosphere. The dried shredded material may be sized and oversized fibre material may be reprocessed, as described with reference to FIG. 4.

The dry shredded fodder DSF is fed to a mixing plant 13 (as shown in FIG. 1) and may be mixed with molasses and/or concentrated juice CJ and/or other liquids to produce a feed meal FM material of suitable moisture content.

As hereinbefore described, other ingredients and additives (eg. vitamins, minerals, antibiotics) may be added to the feed meal FM in the mixing plant 13.

In the embodiment shown in FIGS. 1 and 2, the feed meal material is fed to a pellet mill plant 14 to be pelletised, and then the pelletised feed product FP is conveyed to a bulk outloading/bagging plant 15 for supply to customers.

It will be readily apparent to the skilled addressee that the pellet mill plant 14 and bulk outloading/bagging plant 15 can be replaced by other suitable processing/dispatch plants to suit the particular intended application/use of the feed products.

The power house 28 can supply power to operate the shredder 11/drying plant 12/mixing plant 13/pellet mill plant 14/bulk outloading/bagging plant 15.

As shown in more detail in FIG. 3, the freshly harvested fodder crop LF is emptied from the full trucks 21 via :a tipper 16 and the fresh fodder is conveyed via a fodder elevator 17 to the shredder 11.

From the shredder 11, the wet shredded fodder WSF is transferred to a counter-current juice dilution/extraction plant 18. Diluted juice DJ is directed to a low temperature juice concentration plant 19, and concentrated juice CJ can be fed to the mixing plant 13, or further processed into a “leaf protein concentrate” as described for example by France Luzerne in Great Britain patent GB 1528783 Vegetable Matter Treatment.

Water W from the low temperature juice concentration plant 19 is recycled to the counter-current juice dilution/extraction plant 18, with excess water EW being sent to a drain 30.

The fibre F, after extraction of the juice, is fed to a vibrating screen 31 and oversize fibre OSF is separated and conveyed back to the fodder elevator for further processing in the shredder 11.

Undersize fibre USF is transferred to the drying plant 12.

As shown in FIG. 4, the undersize wet fibre USF is dried by the hot dry gas HDG via a drying system in the drying plant 12. The dried fibre and gas mixture is fed to a gas/solids separator 32 and the wet gas is drawn off by a fan 33 and vented to atmosphere.

The dried fibre DF, from the separator 32, may be directed to an optional size separation subsystem 34, where a particle size separation device 35 separates the fibre into coarse dry fibre CDF (e.g. stems) and fine dry fibre FDF (e.g. leaf).

The coarse dry fibre CDF may be subjected to an optional degritting subsystem 38, where a vibrating screen 39 separates grit GR (suitable for recycling to farms via mill mud) from the coarse dry fibre CDF.

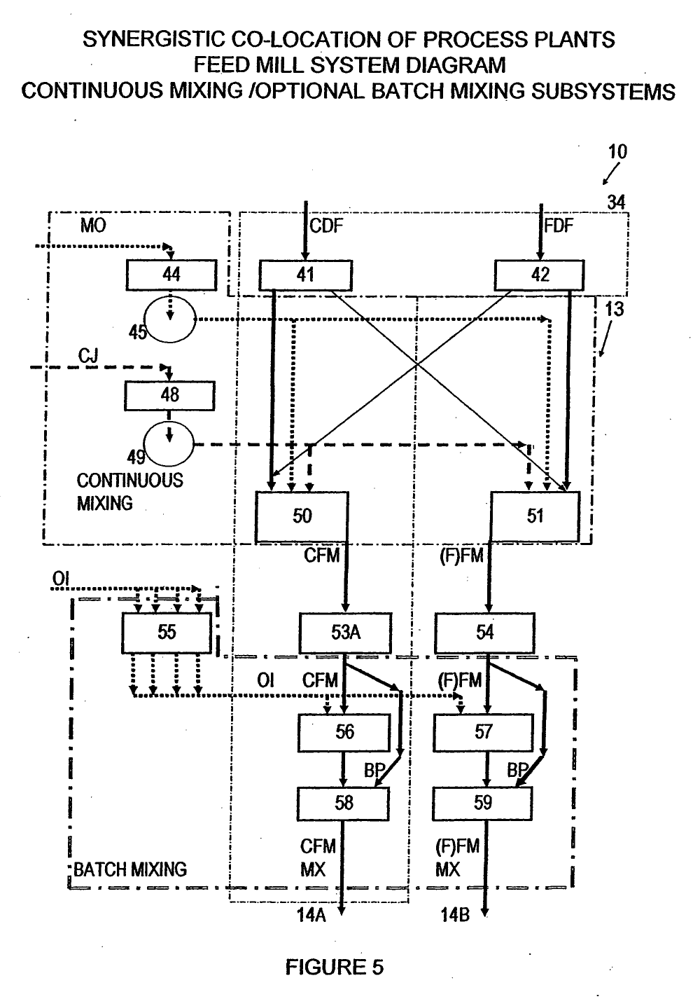

In the mixing plant 13, shown in more detail in FIG. 5, coarse dry fibre CDF via a proportioning diverter 41; fine dry fibre FDF, via a proportioning diverter 42; molasses MO (supplied from the mill tank 25 or processing unit 24), stored in a heated molasses tank 44, with pump 45; and/or concentrated juice CJ, stored in concentrate tank 48, with pump 49; are selectively fed to a continuous coarse feed mixer 50 and continuous fine feed mixer 51, to produce respective coarse and fine feed meal, CFM and FFM, received in respective coarse and fine feed meal holding bins 53A, 54.

Other ingredients OI (e.g. vitamins, other feedstuff nutrients) are held in other ingredients holding bins 55 and are supplied to respective batch mixers 56,57 for mixing with the coarse and fine feed meals and thereby supply to the respective coarse and fine batch holding bins 58,59. (The coarse and fine feed meals may bypass BP the batch mixers 56,57.) The coarse and fine batch holding bins 58,59 supply the pellet mill plant 14.

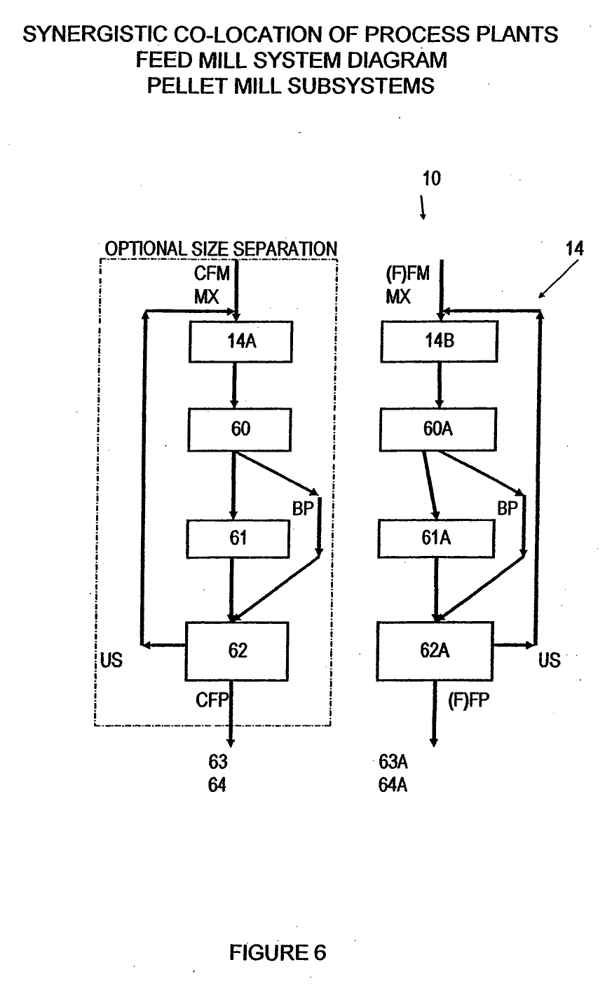

As shown in FIG. 6, the coarse feed meal/mix CFM MX from the coarse batch holding bin 58 is fed to a pellet mill 14A to be pelletised, and then to a cooler 60. The cooled pellets may bypass the crumbler 61, and are fed to a vibrating screen 62, where undersize pellet particles and dust US are returned to the incoming coarse feed meal/mix for reprocessing.

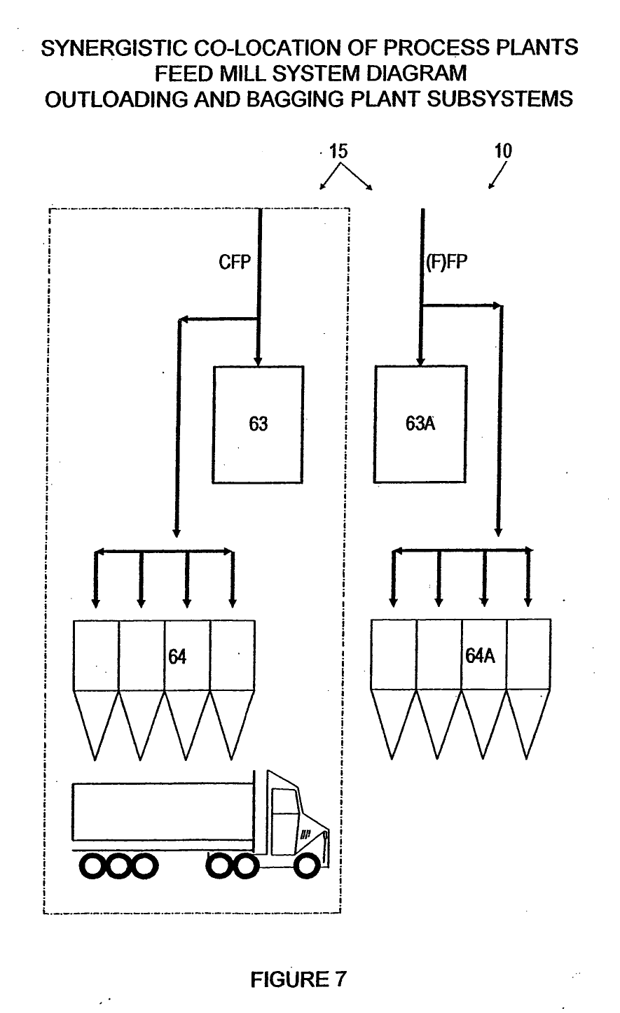

The coarse feed product CFP can be directed to bagging operations 63 and/or bulk outloading bins 64, as shown in FIG. 7.

The fine feed meal/mix (F) FM MX is converted to (fine) feed product (F) FP following a similar path through pellet mill 14B, cooler 60A, crumbler 61A, vibrating screen 62A, bagging operations 63A, and bulk outloading bins 64A.

It will be readily apparent to the skilled addressee that the processing steps, other ingredients added, moisture content and the like can be varied to suit the particular intended application(s) of the feed products.

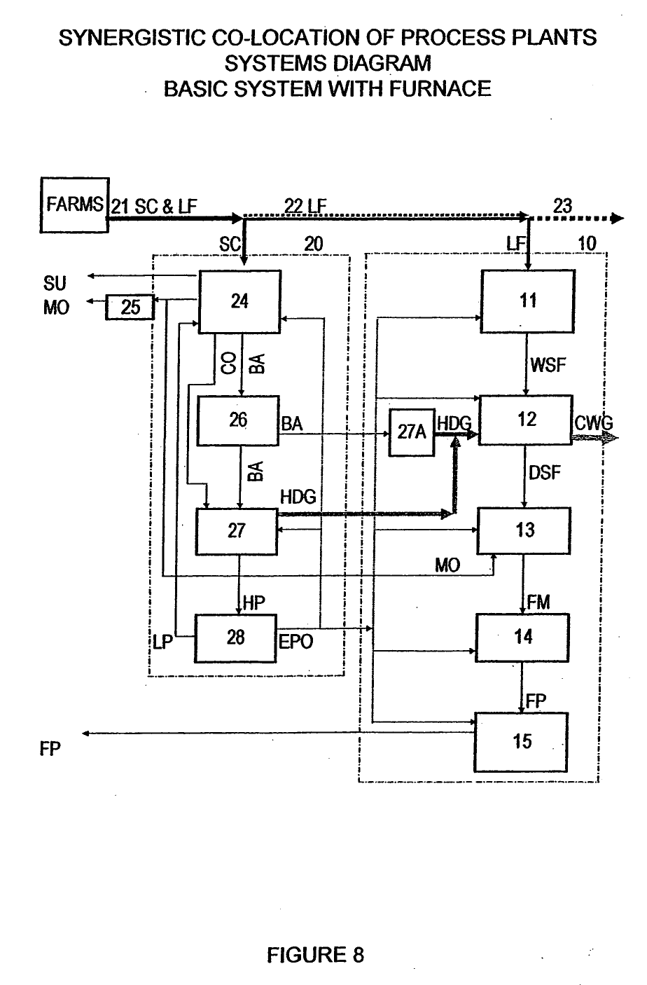

FIG. 8 illustrates a modified embodiment of FIG. 1 where the hot dry flue gas HDG to dry the wet shredded fodder, in the drying plant 12, is provided by the boiler 27 of the sugar cane mill 20 and/or by a separate furnace 27A, located at the feed mill 20, which bums bagasse from the bagasse stockpile 26.

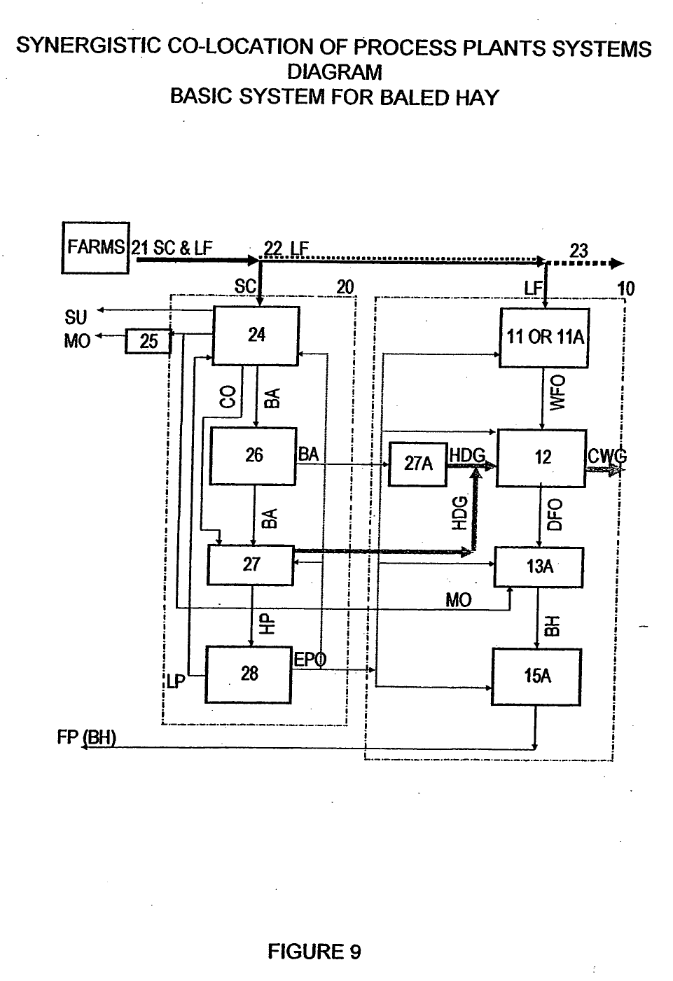

FIG. 9 illustrates a further embodiment where the legume fodder crop is converted to baled hay BH as the delivered feed product FP with or without the addition of molasses MO.

The legume fodder LF crop is delivered to the feed mill 10 as hereinbefore described.

The fodder crop may be fed to rotary knives 11A, where the fibre is cut into shorter pieces (and may be at least partially shredded).

The wet fodder WFO is then dried in the drying plant 12, as hereinbefore described.

The dried fodder DFO is conveyed to a baler 13A, where it may be mixed with molasses to increase the nutritional value of the fodder, before being baled.

The resultant baled hay BH is transferred to an outloading/containerisation plant 15A for transport to the end users.

Advantages of the preferred embodiments of the present invention include:

A. Basic Process Advantages

1. Immediate post harvest processing minimises loss of nutrients.

2. Maximum cell breakage improves availability and digestibility of nutrients.

3. Drying prevents microbiological degradation of nutrients.

4. Process fits in with sugar mill processes to extend the economic utilisation of capital equipment in sugar mills.

5. Results in more effective use of the energy available in the sugar mill's by-product bagasse enabling more economic value to be added to the legume fallow crop thereby generating more income for the major stakeholders in the cane sugar industry. This opportunity is not available in the competing beet sugar industry and so presents a sustainable competitive advantage for the cane sugar industry over the beet sugar industry.

6. Raw material crop can be selected to fit in with sugar cane farming systems.

B. Potential Process Modifications

1. The basic process may be improved by extracting the juice from the freshly shredded material prior to drying the fibrous residue.

2. The juice extracted may be concentrated at a relatively low temperature so as not to damage its nutrient value and further processed to concentrate, flocculate and separate its precipitable protein content. This concentration could be done by evaporation under partial vacuum or by a membrane process such as ultrafiltration, nanofiltration or reverse osmosis provided such process did not harm the nutrient value of the juice.

3. The dried material, whether the juice has been extracted or not, may be separated by physical means such as screening and/or aerodynamic separation techniques into stem material and leaf material.

4. The separated leaf and stem materials, and the concentrated juice may be used to make a range of specially formulated products.

C. Advantages of Potential Process Modifications

1. Leaf material is more digestible and of higher nutritional value than stem material.

2. Leaf, stem and concentrated juice can be recombined in varying proportions from 0% to 100% of any of them and with other ingredients to produce a number of specially formulated feed products.

3. Physical separation processes can also be used to remove mineral particles (grit) above a certain particle size.

The inventor has calculated out a typical seasonal scenario to take into account likely seasonal variations in lucerne growth rates and also to maximise the quantity of lucerne able to be processed given a limited quantity of sugar cane.

The implications of this calculation are:

1. The lucerne processing rate needs to vary from 60% to 150% of the average rate;

2. The energy efficiency of the sugar mill process must be maximised (i.e., steam consumption minimised);

3. The generation of hot gas from incineration of bagasse in a separate furnace (not forming part of a boiler) needs to be carried out throughout the year to a greater or lesser extent depending on the lucerne processing rate and the sugar mill process steam demand; and

4. Approximately 20% of the total bagasse produced must be stockpiled for use during the non-crushing season.

D. Overall Benefits of the Process

The principal technology innovation is taking a legume crop, such as lucerne, grown as a soil enhancing fallow crop within the sugar cane cropping cycle, and dehydrating it at a processing plant co-located with a cane sugar mill and using some of the sugar mill's excess fibre by-product bagasse as the energy source for the dehydration process. The end product of this process is an animal feed product, e.g. lucerne hay, which is a high value commodity both nutritionally and economically.

The benefits of this system are:

(i) The production of a high value additional product within the sugar cane cropping cycle at minimal cost; and

(ii) The synergistic effect of improved sugar yields per unit of farm area from the use of a legume fallow crop. This is brought about by:

a. improved the soil structure from deep rooting perennial legumes such as lucerne;

b. improved soil biochemistry from the fixing of nitrogen in the legume roots and the ploughing in of the final post harvest stubble;

c. reduced incidence of disease and parasites of the sugar cane plant brought about by breaking the biological cycles of these with the introduction of the legume crop into the cropping cycle; and

d. in certain situations, lucerne in particular will assist in reducing soil salinity problems.

The critical advantage is generating substantially more income and profitability for core sugar industry stakeholders i.e., growers and millers, within an integrated farming, processing and logistics system. The production of the animal feed products may increase income by e.g. 20-30%.

Various changes and modifications may be made to the embodiments described and illustrated without departing from the scope of the present invention.

### Synergistic Co-Locatioon of Process Plants

### Diagrams Legend

| ITEM | DESCRIPTION |
|---|---|
| 10 | FEED MILL PLANT |
| 11 | SHREDDER |
| 11A | ROTARY KNIVES |
| 12 | DRYING PLANT |
| 13 | MIXING PLANT |
| 13A | BALER |
| 14 | PELLET MILL PLANT |
| 14A | PELLET MILL (COARSE) |
| 14B | PELLET MILL (FINE) |
| 15 | BULK OUTLOADING/BGGING PLANT |
| 15A | BALE OUTLOADING/CONTAINERISATION |
| 16 | TIPPER |
| 17 | FODDER ELEVATOR |
| 18 | JUICE EXTRACTION PLANT |
| 19 | JUICE CONCENTRATION PLANT |
| 20 | SUGAR MILL PLANT |
| 21 | FULL TRUCKS |
| 22 | COMMON TRANSPORT SYSTEM |
| 23 | EMPTY TRUCKS |
| 24 | SUGAR MILL PROCESS |
| 25 | MOLASSES TANK AT SUGAR MILL |
| 26 | BAGASSE STOCKPILE |
| 27 | BOILER |
| 27A | FURNACE |
| 28 | POWER HOUSE |
| 29 | |
| 30 | DRAIN |
| 31 | VIBRATING SCREEN PRE-DRYING |
| 32 | GAS/SOLIDS SEPARATOR |
| 33 | FAN |
| 34 | OPTIONAL SIZE SEPARATION SUBSYSTEM |
| 35 | PARTICLE SIZE SEPARATION DEVICE |
| 36 | |
| 37 | |
| 38 | OPTIONAL DEGRITTING SUBSYSTEM |
| 39 | VIBRATING SCREEN (DEGRITTING) |
| 40 | |
| 41 | PROPORTIONING DIVERTER (COARSE) |
| 42 | PROPORTIONING DIVERTER (FINE) |
| 43 | |
| 44 | MOLASSES TANK AT MIXING PLANT |
| 45 | MOLASSES PUMP |
| 46 | |
| 47 | |
| 48 | CONCENTRATED JUICE TANK |
| 49 | CONCENTRATED JUICE PUMP |
| 50 | COARSE FEED MIXER (CONTINUOUS) |
| 51 | (FINE) FEED MIXER (CONTINUOUS) |
| 52 | |
| 53 | |
| 53A | COARSE FEED MEAL HOLDING BIN |
| 54 | (FINE) FEED MEAL HOLDING BIN |
| 55 | OTHER INGREDIENTS HOLDING BINS |
| 56 | BATCH MIXER (COARSE) |
| 57 | BATCH MIXER (FINE) |
| 58 | COARSE BATCH HOLDING BIN |
| 59 | (FINE) BATCH HOLDING BIN |
| 60 | COOLER (COARSE PRODUCTS) |
| 60A | COOLER (FINE PRODUCTS) |
| 61 | CRUMBLER (COARSE PRODUCTS) |
| 61A | CRUMBLER (FINE PRODUCTS) |
| 62 | VIBRATING SCREEN (COARSE PRODUCTS) |
| 62A | VIBRATING SCREEN (FINE PRODUCTS) |
| 63 | BAGGING OPERATIONS (COARSE PRODUCTS) |
| 63A | BAGGING OPERATIONS (FINE PRODUCTS) |
| 64 | BULK OUTLOADING BINS (COARSE PRODUCTS) |
| 64A | BULK OUTLOADING BINS (FINE PRODUCTS) |
| BA | BAGASSE |
| BH | BALED HAY |
| BP | BYPASS |
| CDF | COARSE DRY FIBRE |
| CFM | COARSE FEED MEAL |
| CFP | COARSE FEED PRODUCT |
| CJ | CONCENTRATED JUICE |
| CO | CONDENSATE |
| CWG | COOL WET GAS |
| DF | DRY FIBRE |
| DFO | DRY FODDER |
| DJ | DILUTE JUICE |
| DSF | DRY SHREDDED FODDER |
| EPO | ELECTRIC POWER |
| EW | EXCESS WATER |
| F | FIBRE |
| FDF | FINE DRY FIBRE |
| (F)FM | FINE FEED MEAL |
| F(FP) | (FINE) FEED PRODUCT |
| FM | FEED MEAL |
| FP | FEED PRODUCTS |
| GR | GRIT |
| HDG | HOT DRY GAS |
| H | HIGH PRESSURE STEAM |
| LF | LEGUME FODDER |
| LP | LOW PRESSURE STEAM |
| MO | MOLASSES |
| MX | MIX |
| OI | OTHER INGREDIENTS |
| OSF | OVERSIZE FIBRE |
| SC | SUGAR CANE |
| SU | SUGAR |
| US | UNDERSIZE |
| USF | UNDERSIZE FIBRE |
| W | WATER |
| WFO | WET FODDER |
| WSF | WET SHREDDED FODDER |

1. A method of processing a legume fodder crop (as hereinbefore defined), including the steps of:
(a) delivering with minimum delay, freshly harvested legume fodder crop to a feed mill located at/adjacent to a cane sugar mill;
(b) processing the crop to seek optimised cell breakage and/or fiberisation (separation of fibre particles) in the resultant shredded material, depending on final product specifications as required; and
(c) drying the shredded material using heat supplied by the cane sugar mill or from by-products of the cane sugar mill to produce a dried animal feed material, suitable for long term storage.

2. A method as claimed in claim 1, including the further step:
(d) mixing the dried material with suitable liquid binder(s) to produce a feed meal material of suitable moisture content as required for use.

3. A method as claimed in claim 1, wherein:
in step (a), the freshly harvested crop is delivered to the feed mill in bulk using a transport system/infrastructure of the cane sugar mill.

4. A method as claimed in claim 1, wherein:
in step (b), the harvested crop is shredded using heavy duty shredder/hammermill machines.

5. A method as claimed in claim 1, wherein:
in step (b), the juice is extracted, concentrated, and stored in liquid concentrate tank(s).

6. A method as claimed in claim 1, wherein:
in step (c), the shredded matter is dried using hot flue gas from the sugar mill boiler, or from a separate furnace fired with sugar cane bagasse either fresh from the cane sugar mill or from a stockpile.

7. A method as claimed in claim 6, wherein:
the dried shredded material is separated into coarse (stem) and fine (leaf) dry fibre fractions, which are optionally selectively recombined during later processing.

8. A method as claimed in claim 2, wherein:
in step (d), the liquid binder(s) include molasses, juice concentrate and other suitable liquids to achieve the desired moisture content.

9. A method as claimed in claim 2, wherein:
during, or after, step (d) other ingredients and additives, including vitamins, minerals, digestion improvers, antibiotics and other pharmaceuticals are added to increase the value of the feed meal material.

10. A method as claimed in claim 2, wherein:
after step (d), the feed meal material undergoes further processing such as pelletising, crumbling, granulation, agglomeration, pressure compaction, cubing, extrusion, moulding, tableting, briquetting, baling or bagging to suit the market requirements.

11. A method of processing a legume fodder crop (as herein before defined) including the steps of:
(a) delivering with minimum delay, freshly harvested legume fodder crop to a feed mill located at/adjacent to a cane sugar mill;
(b) processing the crop to produce cut and/or shredded material; and
(c) drying the cut and/or shredded material using heat supplied by the cane sugar mill or from by-products of the cane sugar mill to produce a dried animal feed material, suitable for long term storage.

12. A method as claimed in claim 11, including the further step:
(d) baling the dried cut and/or shredded material (or hay).

13. A method as claimed in claim 11, wherein:
in step (b), the crop is processed using rotary knives to cut and/or shred the fibrous material.

14. A method as claimed in claim 12, wherein:
after step (d), the baled material (or hay) is outloaded or containerised for transport.

15. A method as claimed in claim 12, wherein:
at step (d), molasses is mixed with the dried material (or hay) to increase the nutritional value thereof.

16. A method of producing an animal feed product including the steps of:
(i) growing a legume fodder crop (as hereinbefore defined) as a soil-enhancing fallow crop for sugar cane;
(ii) harvesting the crop;
(iii) delivering with minimum delay, freshly harvested crop to a feed mill located at/adjacent to a cane sugar mill;
(iv) processing the crop to seek optimised cell breakage and/or fiberisation (i.e., separation of fibre particles) in the resultant shredded material, depending on final product specifications as required; and
(v) drying the shredded material using heat supplied by the cane sugar mill or from by-products of the cane sugar mill to produce an animal feed material.

17. A method as claimed in claim 16, including the further step:
(vi) mixing the dried material with suitable liquid binder(s) to produce a feed meal material of suitable moisture content if required for use.

18. A method for producing an animal feed product including the steps of:
(i) growing a legume fodder crop (as hereinbefore defined) as a soil-enhancing fallow crop for sugar cane;
(ii) harvesting the crop;
(iii) delivering with minimum delay, freshly harvested crop to a feed mill located at/adjacent a cane sugar mill;
(iv) processing the crop to produce cut and/or shredded material; and
(v) drying the cut and/or shredded material using heat supplied by the cane sugar mill or from by-products of the cane sugar mill to produce an animal feed material.

19. A method as claimed in claim 18, including the further step:
(vi) baling the dried cut and/or shredded material (or hay).

20. A method for producing an animal feed product including the steps of:
(i) growing a legume fodder crop (as hereinbefore defined) as a soil-enhancing fallow crop for sugar cane;
(ii) harvesting the crop; and
(iii) processing the crop by the method claimed in claim 1.

21. A method for producing an animal feed product including the steps of:
(i) growing a legume fodder crop (as hereinbefore defined) as a soil-enhancing fallow crop for sugar cane;
(ii) harvesting the crop; and
(iii) processing the crop by the method claimed in claim 11.
